(19) United States
(12) Patent Application Publication
(10) Pub. No.: US 2017/0100892 A1
(43) Pub. Date: Apr. 13, 2017

(54) FILAMENT DISPENSING ASSEMBLY FOR 3D PRINTED OBJECTS

(71) Applicant: 3D FAB LAB LTD., Chai Wan (HK)

(72) Inventors: Robert Grosche, Springwood NSW 2777 (AU); Veit Grosche, Springwood NSW 2777 (AU)

(21) Appl. No.: 15/207,920

(22) Filed: Jul. 12, 2016

(30) Foreign Application Priority Data
Oct. 9, 2015 (PH) 12015000343

(51) Int. Cl. B29C 67/00; B29C 35/02

(52) U.S. Cl. CPC B29C 67/0074; B29C 35/0277; B33Y 30/00

(57) ABSTRACT

This invention relates to a filament dispensing assembly for 3D printed objects that could manufacture particular products of excellent quality and high quantity according to its programmed specifications or special features. The filament dispensing assembly for 3D printed objects generally comprises an electric motor, a feeding roller being driven by the electric motor, a pressure wheel parallely provided with the feeding roller, a cooling fin jacketed filament tube being provided below said feeding roller, a heater being provided at the bottom end of the cooling fin jacketed tube, a dispensing nozzle being provided below said heater, and a cooling fan being provided at the lower side of the assembly and facing said heater. The feeding roller is characterized by its abrasive surface.

### CROSS-REFERENCE TO RELATED APPLICATION

This application claims the benefit of Phillippines Patent Application No. 12015000343, filed Oct. 9, 2015, the entire disclosure of which is incorporated here by reference.

### TECHNICAL FIELD

This invention generally relates to product manufacturing but more particularly to a filament dispensing assembly for 3D (three-dimensional) printed objects.

### BACKGROUND

Conventional product forming or manufacturing is generally done by hand crafting of various components or compositions being manually assembled into a particular product or by pre-shaped moulds with the use of special forms, tools or machines. As the manufacturing process normally relay on workers skills and well being, productivity may be dependent on his technical competence and state of health.

While there may be some filament dispensing assemblies for 3D printed objects currently in operation, they use a driven gear or longitudinally toothed wheel or roller in their feeding mechanisms. As longitudinally toothed wheel or roller is regularly available and used, it has displayed a number of observable drawbacks, such as, slippage of the feed filament and formation of dust or scraping of filament. The cumulative deposit of dust formed could cause the jamming of filament dispensing assembly, particularly at the extruding portion thereof.

### SUMMARY OF THE INVENTION

In view of the foregoing, it is one object of this invention to provide a filament dispensing assembly for 3D printed objects that could manufacture particular products of excellent quality and high quantity according to its programmed specifications or special features.

Another object of this invention is to provide a filament dispensing assembly for 3D printed objects that embodies certain characterizing features, such as, a filament feeding abrasive wheel, a multi-functional assembly with adapter, a collapsible construction or structure, an upgradable electronic components, and object bending correcting table top, and a rubber insulator as an anti-burn protector at the heater portion of the filament dispensing assembly.

Other objects and advantages of the present invention for a filament dispensing assembly for 3D printed objects will be fully understood and readily appreciated after reading the following detailed description made in conjunction with the accompanying drawings.

### BRIEF DESCRIPTIONS OF THE DRAWINGS

FIG. 1 is a perspective view of a filament dispensing assembly for 3D printed objects.

FIG. 2 is a fragmentary perspective view of a driven feed roller or wheel filament dispensing assembly.

FIG. 3 is a sectional view of the driven feed roller taken along line 3-3 in FIG. 2.

FIG. 4 is a perspective view of a heater of the filament dispensing assembly being shown with a spacedly provided heat insulating rubber jacket.

FIG. 5 is a perspective view of a stand for the filament dispensing assembly.

FIG. 6 is a perspective view of a bending correction panel.

### DETAILED DESCRIPTION

Referring now to the drawings there is shown in FIG. 1 the present filament dispensing assembly designated in its entirety by reference numeral 10 and generally comprising an electric motor 11, a feeding roller 12 being driven by the electric motor 11, a pressure wheel 13 parallely provided with the feeding roller 12, a cooling fin jacketed filament tube 14 being provided below said feeding roller 12, a heater 15 being provided at the bottom end of the cooling fin jacketed filament tube 14, a dispensing nozzle 16 being provided below said heater 15, and a cooling fan 17 being provided at the lower side of the assembly 10, preferably, facing said heater 15.

As shown in FIGS. 2 and 3, the feeding roller 12 is characterized by its abrasive surface 18 specifically featuring diamond particles studded surfaces. The abrasive surface 18 is formed by chrome-plating a roller shaft 19 being dusted or applied with diamond particles or other equivalent materials.

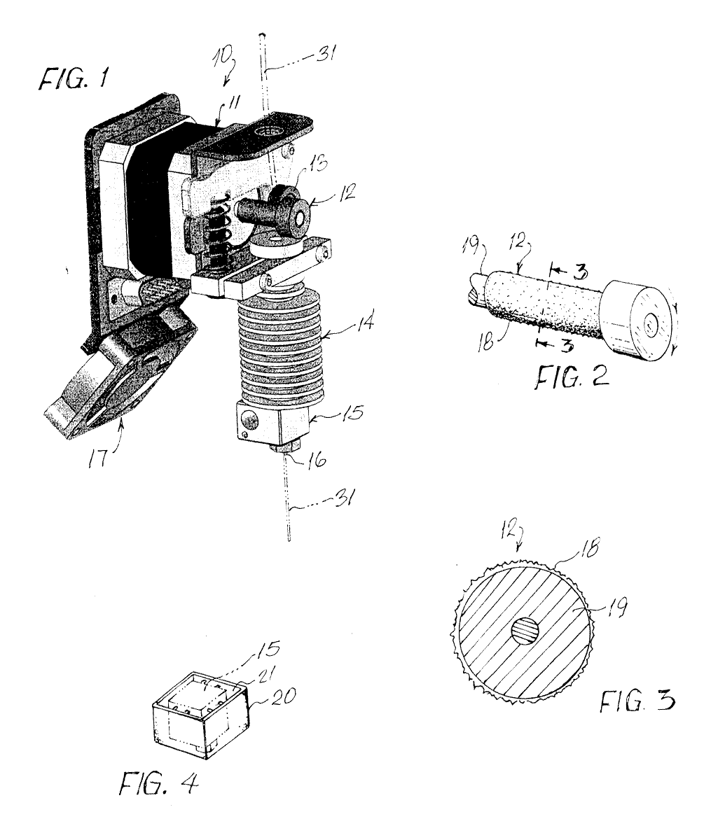

FIG. 4 shows the heater 15 being provided with spacedly positioned or fitted with a rubber jacket 20 to thereby define a space or gap 21 which allow air passage thereat. The rubber jacket 20 functions as an anti-burn protection means to safeguard human operator from having himself being accidentally hurt by the hot surfaces around the heater 15.

FIG. 5 shows a preferred stand 22 for the filament dispensing assembly 10. Furthermore, the stand 22 is preferably collapsible for compact storage or transport. The stand 22 is generally defined by a triangular frame 23 having a vertical sub-frame 24 and a horizontal sub-frame 25 being supported by braces 26 at their free ends. The vertical sub-frame 24 has a wired adapter head 27 at its upper portion. Said adapter head 27 having clipping fingers 28 which will securely hold the filament dispensing assembly 10 thereat. The horizontal sub-frame 25 has a sliding working table 29 being provided at the middle portion thereof.

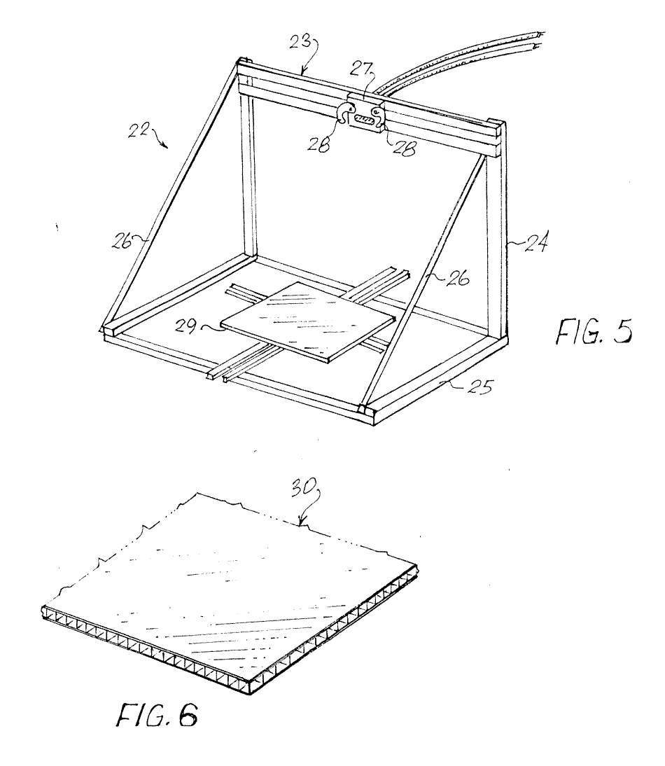

FIG. 6 shows a bending correction panel 30 being defined by a corrugated fibre board having hollowed spaces or air gaps to allow cooling air passage.

Other preferred materials may include poly carbonate or aluminium sheets featuring aforesaid hollowed spaces or air gaps to allow gradual cooling of an object being formed by the present invention. The bending correction panel 30 is to be positioned on the top of sliding working table 29.

In operation, a plastic filament 31 is uncoiled from a spool (not shown) and its end being inserted or fitted between the feeding roller 12 and pressure wheel 13. Once the filament dispensing assembly 10 is electrically powered, the motor driven feeding roller 12 will downwardly feed the filament to the filament tube 14 and to the heater 15 being provided at the lower end of the filament tube 14. In the heater 15, the filament 31 becomes soft and extruded through the dispensing nozzle 16.

The dispensed filament 31 is gradually applied or laid on an object pattern defined by the programmed specification.

The stand 22 of the filament dispensing assembly 10 may be provided with a plurality of adapter heads 27 which could be variably fitted with programmable assemblies of different functional applications or operations.

While the invention has been disclosed in connection with the preferred embodiments shown and described in detail, various modifications, innovations and improvements thereon will become readily apparent to those skilled in the art. Accordingly, the spirit and scope of the present invention is not limited by the foregoing example but is to be understood in the broadest sense allowable by law.

What is claimed is:

1. A filament dispensing assembly for 3D printed objects, comprising: an electric motor, a feeding roller being driven by the electric motor, a pressure wheel parallely provided with the feeding roller, a cooling fin jacketed filament tube being provided below said feeding roller, a heater being provided at the bottom end of the cooling fin jacketed tube, a dispensing nozzle being provided below said heater and a cooling fan being provided at the lower side of the assembly and facing said heater, said feeding roller being characterized by its abrasive surface.

2. A filament dispensing assembly for 3D printed object according to claim 1 wherein said heater is being spacedly fitted with rubber jacket.

3. A filament dispensing assembly for 3D printed objects according to claim 2 wherein said assembly is being mounted at a stand, said stand being characterized by a triangular frame comprising a vertical sub-frame and a horizontal sub-frame, said sub-frames being supported by braces at their free ends, said stand having a working table at its horizontal sub-frame, said filament dispensing assembly being securely held at a wired adapter head provided at the upper portion of the vertical sub-frame.

4. A filament dispensing assembly for 3D printed objects according to claim 3 wherein said stand is being provided with a plurality of adapter heads being variably fitted with programmed assemblies of different functional operations.
